(19) United States
(12) Patent Application Publication
(10) Pub. No.: US 2004/0026537 A1
(43) Pub. Date: Feb. 12, 2004

(54) Fuel injector having control valve members connected in series

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/332,380

(22) PCT Filed: Apr. 26, 2002
(86) PCT No.: PCT/DE02/01542

(30) Foreign Application Priority Data
May 8, 2001 (DE) 101 22 246.7

(51) Int. Cl. F02M 59/00

(52) U.S. Cl. 239/533.3

(57) ABSTRACT

The invention relates to a fuel injector for injecting fuel into the combustion chamber of an internal combustion engine. The fuel injector includes an injector body (2), in whose housing bore (8) a first 3/2-way control valve (6) is received, whose valve body (7) has a slide portion (18) and a seat diameter (11). The valve body (7) of the 3/2-way control valve (6) is actuated via an actuator (40) directly or indirectly via transmission elements (3, 4). By means of the valve body (7) of the 3/2-way control valve (6), a valve member (30) of a further control valve (29) is forcibly controlled via a transmission element (26), which in a first position of the valve body (7) in the housing bore (8) is spaced apart from the valve body by a gap size h₁ (25).

### FIELD OF THE INVENTION

In motor vehicles with air-compressing internal combustion engines, fuel injection systems are used whose fuel injectors are subjected to fuel by way of the interposition of high-pressure collection chambers (common rails). The onset of injection and the injection quantity are set with the electrically triggerable injector. The fuel injectors are built into the cylinder head of the engine, without having to make substantial modifications to it. Depending on the intended use, whether in passenger cars or utility vehicles, influence on the course of the injection can be exerted by means of whichever injectors are used.

### PRIOR ART

European Patent Disclosure EP 0 987 432 A2 relates to a fuel injector. It includes a nozzle needle, which is pressed into its seat via a spring element. The end face of the nozzle needle is acted upon by way of the fuel pressure in a control chamber in which fuel flows in via a supply line in which a throttle element is received. An outlet valve, which controls the outflow of fuel from the supply line into a low-pressure region, and a control valve which opens or closes the communication between the control chamber and the low-pressure region are received in the fuel injector as well. The outlet valve and the control valve are actuated via a common electromagnetic actuator. The actuator is received in a housing that surrounds the outlet valve and the control valve. The control valve, outlet valve and actuator are disposed such that in the deactivated state, the outlet valve and the control valve are in their respective open positions. If the actuator is moved into a first position, which is equivalent to a first current supply level, the outlet valve is closed while the control valve remains in its open position. If the electromagnetic actuator receives further current, conversely, and reaches a second, higher current supply level, then the control valve is closed as well.

With this embodiment, the injection is terminated by the deactivation of the actuator, and the outlet valve is initially open. Since shortly before the opening of the outlet valve the control valve is still open, the pressure counter to which the spring element of the nozzle needle works upon closure of the nozzle can be lowered, making a faster needle closure attainable.

European Patent Disclosure EP 0 994 248 A2 is directed to a fuel injector with injection course shaping by a piezoelectric actuator. An injection opening is embodied on the injector body of the fuel injector. A nozzle needle is received movably in the injector body and can be moved back and forth between a position in which it opens the injection opening and a position in which it closes the injection opening. A piezoelectric actuator is received in the injector body and is movable between an active and an inactive position. By means of a coupling element, the nozzle needle and the piezoelectric actuator are joined to one another, so to convert the motion of the piezoelectric actuator into a greater motion of the nozzle needle upon its stroke in the injector body.

### SUMMARY OF THE INVENTION

With the embodiment according to the invention, a combination of a pressure-controlled, partially pressure-balanced control valve with a positive-controlled, stroke-controlled control valve can be attained. With the use of a piezoelectric actuator, a direct triggering of the pressure-controlled, partially pressure-balanced control valve, which is preferably embodied as a 3/2-way control valve, can be accomplished. A direct triggering of the 3/2-way valve allows its graduated adjustment. The coupling between the pressure-controlled 3/2-way control valve and the positive-controlled, stroke-controlled control valve downstream of it is effected by means of a rodlike transmission element. This element can be surrounded by a cup-shaped recess in the 3/2-way control valve. An idle stroke can be set between the contact face of the transmission element and the contact face of the 3/2-way control valve body. By means of this idle stroke, the instant of opening and closing of the 2/2-way valve that relieves the control chamber pressure can be set in such a way that the nozzle chamber surrounding the nozzle needle is already subjected, by means of the partly open 3/2-way control valve, to fuel that is at high pressure.

With the embodiment proposed according to the invention, a pressure relief of a control chamber that acts on the nozzle needle can be attained in timely fashion and after the imposition of pressure on the nozzle chamber surrounding the nozzle needle. At the 3/2-way control valve, which is preferably designed as a seat/slide valve, upon partial closure a closure of the downstream 3/2-way control valve can be attained on the one hand; as long as the 3/2-way control valve has moved out of its seat in the injector housing, and the slide part embodied on it is still closed, the fuel injector acts as a stroke-controlled injector. Upon complete closure of the 3/2-way control valve into its seat, a pressure relief of the nozzle inlet and hence of the nozzle chamber of the nozzle needle into the leak fuel outlet takes place.

Simultaneously, a closure of the nozzle needle takes place as a result of a pressure buildup in the control chamber via the inlet bore with the inlet throttle, which bore branches off from the nozzle inlet.

### DRAWING

The invention will be described in further detail in conjunction with the drawing.

Shown are:

FIG. 1, a series connection of a 3/2-way control valve and a 2/2-way control valve, above a control chamber that acts on the nozzle needle;

FIG. 2, a booster piston assembly received above the 3/2-way control valve.

### VARIANT EMBODIMENTS

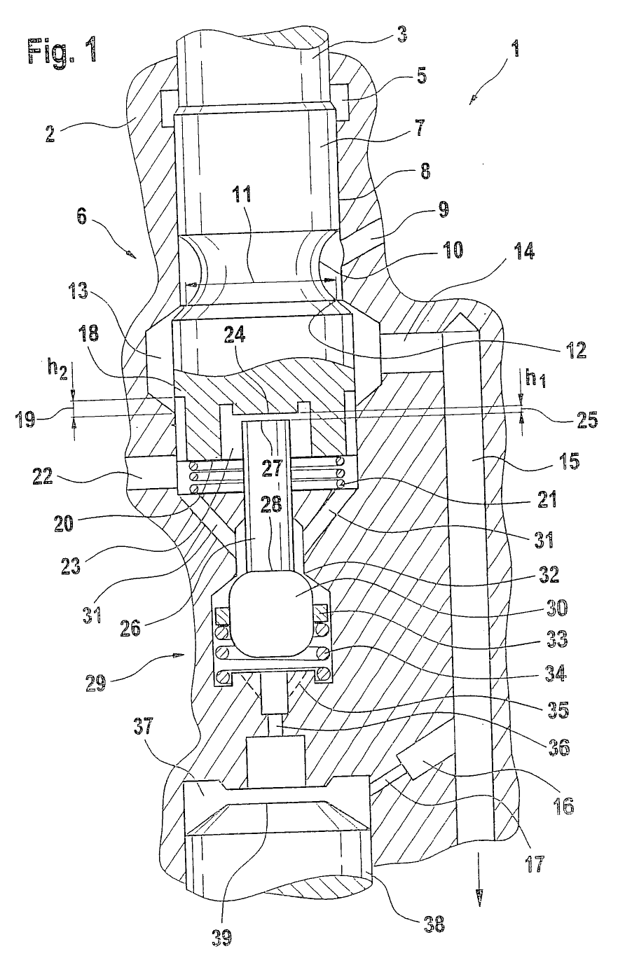

The illustration in FIG. 1 shows the series connection of a 3/2-way control valve and a 2/2-way control valve above a control chamber that acts on the nozzle needle.

A housing bore 8 is embodied in the injector body 2 of an injector 1 for injecting fuel into the combustion chamber of an internal combustion engine. A valve body 7 of a control valve 6, preferably embodied as a 3/2-way control valve, is received movably in the housing bore 8. The upper end face of the valve body 7 protrudes into a booster chamber 5. The end face of a booster piston 3, facing the end face of the valve body 7, protrudes into this booster chamber 5 and is actuatable via an actuator 40, not shown in FIG. 1. The actuator 40 can also act directly on the end face, pointing toward it, of the valve body 7 of the first 3/2-way control valve 6.

At the valve body 7 there is a constriction 10, into the region of which in the injector body 2 an inlet 9 of a high-pressure collection chamber (common rail), not shown here, discharges. The constriction 10 at the valve body 7 tapers conically in the direction of the valve chamber 13. A seat diameter 11, which with a first seat face 12 of the injector body 2 forms the seat of the valve body 7, is embodied in the lower region of the constriction 10.

The valve body 7 of the first 3/2-way control valve 6 is surrounded by a valve chamber 13 in the injector body 2 that communicates via a branch 14 with a nozzle inlet 15. The nozzle inlet 15 in turn discharges into a nozzle chamber, not shown in FIG. 1, which surrounds a nozzle needle, also not shown, in the lower region of the injector body 2. From the nozzle inlet 15, an inlet 16 branches off toward a control chamber 37. An inlet throttle 17 is received in the inlet 16 to the control chamber 37.

The valve body 7 of the first control valve 6, which valve is preferably embodied as a 3/2-way control valve, is provided in its lower region with a slide part 18. The overlap of the slide edge of the slide part 18 of the valve body 7 is identified by reference numeral 19 (h₂). In the lower region of the valve body 7 there is a cup-shaped hollow chamber 23, which on its side pointing toward a bolt like transmission element 26 has a contact face 24. The valve body 7, on its lower end, includes an annularly configured end face 20, on which a restoring element embodied as a spiral spring 21 rests. The restoring element 21 is received in a hollow chamber in the injector body 2 from which both a leak fuel outlet 22 and bores 31 branch off.

The boltlike transmission element 26, received in the injector body 2 coaxially to the axis of symmetry, rests with its lower end face 28 on the spherically embodied valve member 30 of a further control valve 29. The further control valve 29 is preferably designed as a 2/2-way control valve. An annular contact face 33 is embodied on the valve member 30 of the further control valve 29, and resting on this face is a further sealing spring 34, which imposes a restoring motion on the spherically embodied valve member 30. The valve member 30 of the further control valve 29, in its closing position, rests on a seat face 32 of the injector body 2. Opposite that, a further seat for the valve member 30, embodied for instance spherically, of the further control valve 29 can be embodied in the injector body 2.

By means of the further valve member 30 of the further control valve 29 in the injector body 2, the control chamber 37 is pressure-relieved above a thrust rod 30, which acts on the nozzle needle not shown here, so that upon pressure relief of the control chamber 37, the control volume received in it flows out into the leak fuel outlet 22 via the outlet throttle 36 and the bores 31 above the seat face 32 in the injector body 2.

In the view shown in FIG. 1, the valve body 7 of the first control valve 6 is in the closing position; that is, the seat diameter 11 of the valve body 7 rests on the seat 12 of the injector body 2. In this position of the valve body 7, a gap size 25 (h₁) is established between the contact face 24 and the upper face end 27 of the transmission element 26 with the boltlike configuration. In the operating state of the injector shown in FIG. 1, the valve member 30 of the further control valve 29 also rests on a seat face 32 in the injector body 2.

In the closing position of both the valve body 7 of the first control valve 7 and the valve member 30 of the further control valve 29, the nozzle inlet 14 communicates with the leak fuel outlet 22, via the valve chamber 13 through the opened slide part 18 of the valve body 7, so that the fuel can flow out from the nozzle chamber via the nozzle inlet to the branch 14 and to the valve chamber 13. In this operating position of the first control valve 6, a gap size 25 is established between the contact face 24 and the end face 27, pointing toward it, of the transmission element 26 with the boltlike configuration. In this operation position, the injector 1 acts as a pressure-controlled injector for injecting fuel into the combustion chamber of an internal combustion engine.

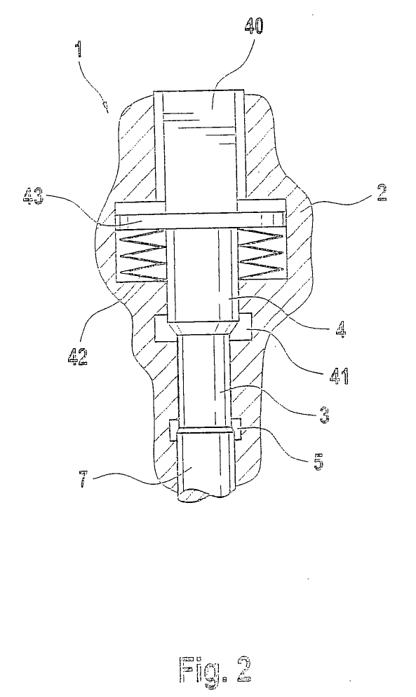

Upon actuation of an actuator 40 not shown in FIG. 1 (see illustration in FIG. 2), the valve body 7 of the first control valve 6 moves downward, so that fuel that is at high pressure from the inlet 9 from the high-pressure collection chamber (common rail), not shown here, shoots into the valve chamber 13 in the injector body 2 of the injector 1. Via the valve chamber 13, the fuel flows via the branch 14 into the nozzle inlet 15 and acts upon the nozzle chamber, not shown here, surrounding the nozzle needle with fuel at high pressure. In the vertical downward motion, the slide part 18 closes the communication between the valve chamber 13 and the leak fuel outlet 22. After the idle stroke 25 between the valve body and the upper face end 27 of the transmission element 26 configured in boltlike fashion is overcome, the valve member 30 of the further control element 29 opens positively. As soon as the valve body 30 of the further control valve 29 in the injector body 2 opens, the control volume in the pressure-relievable control chamber 27 flows via the outlet throttle 36 into the hollow chamber, in which the valve member 30 of the control valve 29, preferably configured as a 2/2-way control valve, is received. Via the opened seat 32, the control volume flows via the bores 31 into the hollow chamber of the injector body 2 in which the spring element 21 is received. From there, the control volume flows out via the leak fuel outlet 22. By means of the pressure relief of the control chamber 37, an outward motion of the thrust rod 38 protruding into the control chamber 37 is accomplished, so that the nozzle needle, communicating with the thrust rod 38, opens injection openings protruding into the combustion chamber of the engine, and the fuel volume present in the nozzle chamber can be injected via the nozzle inlet 15 into the combustion chamber of the engine.

By means of the actuator, not shown in FIG. 1, the valve body 7 of the first control valve 6 can be adjusted in graduated fashion. Given the graduated adjustability of the valve body 7 of the first control valve 6 in the housing bore 8 of the injector body 2, upon partial closure of the valve body 7 in the direction of its seat 12 in the injector body 2, the valve member 30 of the further control valve 29 can also move inward into its seat 32. This terminates the pressure relief of the control chamber 37 through the outlet throttle 36, and a pressure buildup takes place in the control chamber 37 by means of the fuel volume entering the inlet 16 with the inlet throttle 17 via the nozzle inlet 15. As a result of the pressure buildup in the control chamber 37, the thrust rod 38 moves vertically downward and thus causes a closure of the injection openings by means of an inward motion of a cone of the nozzle needle into its seat.

Upon partial closure of the valve body 7, it is true that there is still an overlap of the slide part 18 with the associated housing edge embodied in the injector body 2, but nevertheless the valve body 7 is still open at its seat 12 toward the housing. In this partly closed operating state of the first control valve 6, the injector 1 functions as a stroke-controlled injector.

Not until further actuation of the actuator 40 (see FIG. 2) does the valve body 7 move vertically upward in the housing bore 8 into its seat 12. As a result, the overlap of the slide part 18 with the associated control edge on the injector body 2 is eliminated, so that a pressure relief of the nozzle inlet 14 via the branch 14 the valve chamber 13 into the leak fuel outlet 22 can be effected. Upon complete closure, that is, inward motion of the valve body 7 into its seat 12 in the injector housing 2, the gap size 25 is established between the contact face 24 of the injector body 7 and the upper end face 27, pointing toward it, of the boltlike transmission element 26. In this state, the further control valve 29 is closed as well; that is, the valve member 30, embodied spherically, for instance, is positioned against its seat 32 in the injector body. By means of the thus-generated pressure buildup in the control chamber 37 in the injector body 2, the nozzle needle, which is connected to the thrust rod 38, is closed positively.

By the definition of the gap size 25 between the contact face 24 of the valve body 7 and the upper end face 27 of the boltlike transmission element 36, the instant at which upon vertical downward motion of the valve body 7 in the housing bore 8 the further control valve 29, downstream of it, opens, or in other words the instant when the control chamber 37 is pressure-relieved, can be determined. As a result, it can be attained that in the valve body 7, partly open via the valve chamber 13, at its seat 12 in the injector housing 2 from the common rail, fuel flowing from the common rail via the inlet 9, branch 14 and nozzle inlet 15 is present in the nozzle chamber, so that immediately after the gap size 25 has been overcome, an upward motion of the thrust rod 38 into the control chamber 37 can occur. Thus immediately after the gap size 25 is overcome, an opening motion of the nozzle needle occurs, so that the fuel volume already present in the nozzle chamber can be injected without delay into the combustion chamber of an internal combustion engine.

In the partly closed state, that is, when the further control valve 29 is closed but the first control valve 6 is still open at its seat 12, the slide part 18 of the injector body 7 is still closed, the injector acts as a stroke-controlled injector. If conversely the first control valve 6 at the seat 12 is closed, that is, blocks the inlet 9 from the common rail, a pressure relief of the injector takes place via the nozzle inlet 15, the branch 14, and the valve chamber 13, into the leak fuel outlet 22. Here the first control valve 6, or in other words its valve body 7, is in the completely open state; the fuel present via the inlet 9 flows via the nozzle inlet 15 to the nozzle, while at the same time the overlap at the slide part 18 with the associated housing control edge becomes operative, and the 2/2-way valve, the further control valve 29, opens by way of the positive control by means of the boltlike transmission element 26. In this state, the injector 1 functions as a pressure-controlled injector.

With the embodiment according to the invention, the advantages of a stroke- and pressure-controlled injector can be combined, by means of a first control valve 6 embodied as a 3/2-way control valve and a 2/2-way valve, positive-controlled by it, that is, a further control valve 29.

FIG. 2 shows a booster piston assembly received above a 3/2-way control valve.

It can be seen from this that above the valve body 7 of the first control valve 6, a piezoelectric actuator 40 is received, which acts on a platelike element 43 received in the valve body 2. The platelike element 43 is braced in turn on a spring assembly 42 and is received on a further booster piston 4. The face end, opposite the plate element 43, of the further booster piston protrudes into a further booster chamber 41 in the injector body 2. Also protruding into this chamber is an upper end face of the first booster piston 3, which in turn, via a booster chamber 5, acts upon the upper end face of the valve body 7 of the first control valve 6 that is preferably configured as a 3/2-way control valve. Instead of a pressure boost designed as a booster piston 3 or 4, however, a mechanical boost in the actuator motion for bringing about an adequate upward and downward motion of the valve body 7, which valve body, via the boltlike transmission element 26, controls the valve member 30 of the further control valve 29 positively.

1. A fuel injector, having an injector body (2) in whose housing bore (8) a first 3/2-way control valve (6) is received, whose valve body (7) has a slide portion (18) and a seat diameter (11) and is actuated by means of an actuator (40) directly or indirectly via transmission elements (3, 4), characterized in that the valve body (7) of the 3/2-way control valve (6) positively controls a valve member (30) of a further control valve (29) via a transmission element (26), which, in a first position of the valve body (7), is spaced apart in the housing bore (8) from the valve body by a gap size h₁ (25).

2. The fuel injector of claim 1, characterized in that the valve body (7) of the first 3/2-way control valve (6) includes a cup-shaped hollow chamber (23).

3. The fuel injector of claim 2, characterized in that the cup-shaped hollow chamber (23) has a contact face (24) for the transmission element (26).

4. The fuel injector of claim 1, characterized in that the valve body (7) in the housing bore (8) of the injector body (2) is actuatable in stages.

5. The injector of claim 4, characterized in that upon opening of the valve body (7) from its seat (11, 12), after the gap size h₁ (25) is overcome, opens the further control valve (29), as a result of which a control chamber (37) is pressure-relieved.

6. The injector of claim 4, characterized in that upon partial closure of the valve body (7), its slide part (18) toward the housing remains in overlap, while the valve member (30) of the further control valve (29) moves into its seat (32).

7. The injector of claim 4, characterized in that upon complete closure of the valve body (7) into its seat (11, 12), a nozzle inlet (14, 15) can be pressure-relieved via a valve chamber (13) into a leak fuel outlet (22).

8. The injector of claim 7, characterized in that upon complete closure of the valve body (7) into its seat (11, 12), the gap size h₁ (25) is established between the valve body (7) and the transmission element (28).

9. The injector of claim 1, characterized in that the valve body (7) of the first 3/2-way control valve (6) and the valve body (30) of the further control valve (29) are acted upon by restoring spring elements (21, 34).

10. The injector of claim 1, characterized in that the further control valve (29) is embodied as a 2/2-way control valve.

11. The fuel injector of claim 9, characterized in that the restoring spring elements (21, 34) rest on annular faces (20, 33) of the valve body (7) and of the valve member (30), respectively.
